(19) United States
(12) Patent Application Publication
(10) Pub. No.: US 2009/0247231 A1
(43) Pub. Date: Oct. 1, 2009

(54) TELECOMMUNICATION DEVICE AND HANDWRITING INPUT PROCESSING METHOD THEREOF

(75) Inventors: ZHI GUO, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/195,431

(22) Filed: Aug. 21, 2008

(30) Foreign Application Priority Data
Mar. 28, 2008 (CN) 200810300771.7

(51) Int. Cl. H04M 1/00; G06F 3/041; G09G 5/00

(52) U.S. Cl. 455/566; 345/173

(57) ABSTRACT

An exemplary telecommunication device includes a touchscreen, a processing unit, a storage unit, a combining unit, and a communication unit. The touchscreen is used for receiving and recording handwriting inputs. The processing unit is adapted for converting each handwriting input into a separate first image having a first predetermined size. The storage unit is used for storing the separate first images generated by the processing unit. The combining unit is configured for combining the separate first images to generate a resulting second image having a second predetermined size. The communication unit is used for sending the resulting second image wirelessly.

### BACKGROUND

1. Field of the Invention

The present invention relates to telecommunication devices, and particularly to a handwriting input processing method for a telecommunication device.

2. Description of related art

Telecommunication devices, such as mobile phones, are widely used for communication over networks. In addition to the standard voice call function, current telecommunication devices support many additional functions, such as short message service (SMS), electronic mail (E-mail), multimedia messaging service (MMS), etc.

When inputting information to a telecommunication device, such as writing a short message or an E-mail, a touchscreen may be used for receiving handwriting input using a stylus or by touch. The telecommunication device may utilize two methods to process the received handwriting inputs. A first method is using handwriting recognition software to convert the handwriting inputs into letter codes. A second method is to record the handwriting inputs on the touchscreen as an image.

However, for the first method, the user's handwriting is not seen by message receivers because the handwriting inputs are converted into text codes. For the second method, limited by a size of the touchscreen, only few handwritten words or symbols can be recorded in the image at a time. It is inconvenient for the user to send the short massage or E-mail using the second method.

Therefore, an improved telecommunication device and a handwriting input processing method for the telecommunication device are needed to address the aforementioned deficiency and inadequacies.

### SUMMARY

An exemplary telecommunication device includes a touchscreen, a processing unit, a storage unit, a combining unit, and a communication unit. The touchscreen is used for receiving and recording handwriting inputs. The processing unit is adapted for converting each handwriting input into a separate first image having a first predetermined size. The storage unit is used for storing the separate first images generated by the processing unit. The combining unit is configured for combining the separate first images to generate a resulting second image having a second predetermined size. The communication unit is used for sending the resulting second image wirelessly. A related handwriting input processing method is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic block diagram of a telecommunication device in accordance with an exemplary embodiment.

FIG. 2a is a schematic diagram showing a first usage status of a telecommunication device in accordance with an exemplary embodiment, the telecommunication device is used for writing a short message.

FIG. 2b is a schematic diagram showing a second usage status of the telecommunication device of FIG. 2a in accordance with an exemplary embodiment.

FIG. 2c is a schematic diagram showing a third usage status of the telecommunication device of FIG. 2a in accordance with an exemplary embodiment.

FIG. 2d is a schematic diagram showing a fourth usage status of the telecommunication device of FIG. 2a in accordance with an exemplary embodiment.

FIG. 2e is a schematic diagram showing a fifth usage status of the telecommunication device of FIG. 2a in accordance with an exemplary embodiment, a message in the form of a resulting second image has been completed.

FIG. 3 is a flow chart illustrating a handwriting input processing method for a telecommunication device in accordance with an exemplary embodiment.

### DETAILED DESCRIPTION OF THE EMBODIMENTS

References will now be made to the drawings to describe exemplary embodiments of the present telecommunication device and handwriting input processing method for the telecommunication device.

When processing inputted messages, such as a short message or an E-mail, the telecommunication device records each handwriting input performed using a stylus or touch in a temporary separate first image having a first size. A handwriting input may take a form of at least one alphanumerical character, words, phrases, and/or symbols. When receiving a control/function selection input, such as a return input for combining the temporary separate first images, or a send input or save input for sending or storing a completed short message or an E-mail including the handwriting inputs, the telecommunication device combines all the separate first images to a resulting second image having a second size, and sends or stores the resulting second image according to the control signal.

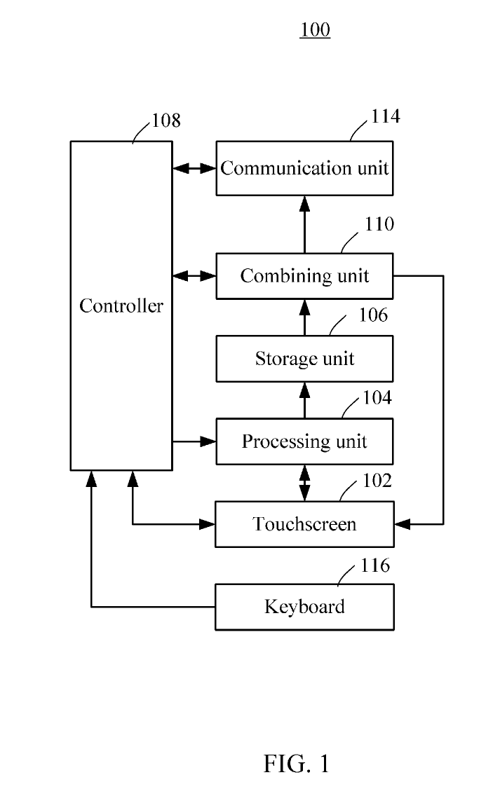

Referring to FIG. 1, a telecommunication device 100 includes a touchscreen 102, a processing unit 104, a storage unit 106, a controller 108, a combining unit 110, a communication unit 114, and a keyboard 116.

The touchscreen 102, as a touch input device and output device, is used for receiving and recording inputs, and displaying the separate first images, the resulting second image, and other viewable information. The inputs may be the handwriting inputs to create/edit short messages or E-mails, or enter other data to the telecommunication device 100. The input may also be control/function selection inputs, such as a menu select input for invoking/viewing a function menu of the telecommunication device 100, a create short message input for opening a text editor, the return input, the send input, or the save input.

In the exemplary embodiment, in a condition that the touchscreen 102 has not been touched for a predetermined time period, it is determined that the handwriting input has been completed. In other embodiments, the handwriting input is determined to be completed when receiving an operational input.

The keyboard 116 including a plurality of keys 118 is another input device of the telecommunication device 100, for receiving the control/function selection inputs, such as the menu select input, the create short message input, the return input, the send input, or the save input.

The processing unit 104 is configured for processing the inputted messages (namely, the handwriting inputs). In detail, the processing unit 104 converts every handwriting input to the separate first image having the first size, and then outputs the separate first image to the storage unit 106 and the touchscreen 102 so as to store and display the separate first image respectively.

The storage unit 106 is used for storing the separate first images generated by the processing unit 104.

The controller 108 is configured for enabling and disabling the processing unit 104 and the combining unit 110 in response to received control/function selection inputs. In detail, when receiving a control/function selection input for enabling a handwriting input processing function, e.g., the create short message input, the touchscreen 102 or the keyboard 116 signals the controller 108 to enable the processing unit 104. When receiving the send input, the touchscreen 102 or the keyboard 116 signals the controller 108 to enable the combining unit 110 and the communication unit 114. The controller 108 can further zoom out the separate first images such that the user can input more handwriting inputs, and zoom in the text editing frame according to user's inputs, such that the user can input larger handwriting inputs.

The combining unit 110 is configured for combining the separate first images stored in the storage unit 106 to generate the resulting second image having the second predetermined size. In the exemplary embodiment, the combining unit 110 generates the resulting second image by appending the separate first images, in consecutive order in accordance with an input order of the handwriting inputs, to a blank image having the second predetermined size. In other embodiments, the separate first images may be combined out-of-order.

The communication unit 114 is used for sending the resulting second image wirelessly to other telecommunication devices or network terminals.

Hereinafter, a handwriting input processing operation of the telecommunication device 100 will be described in detail.

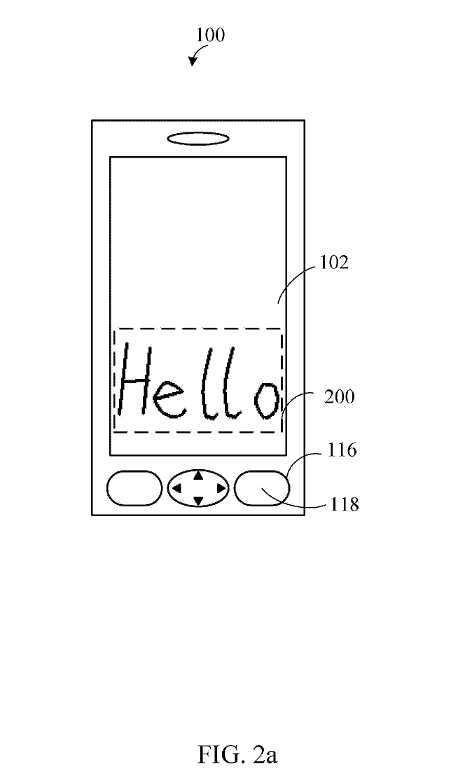

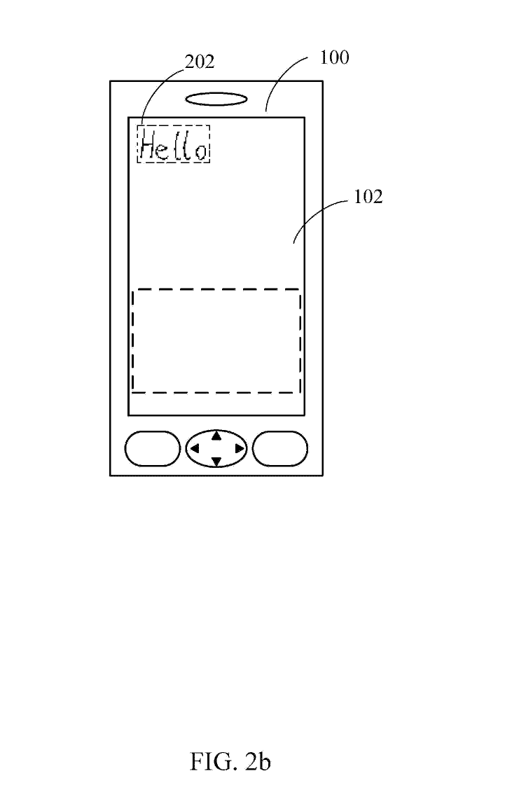

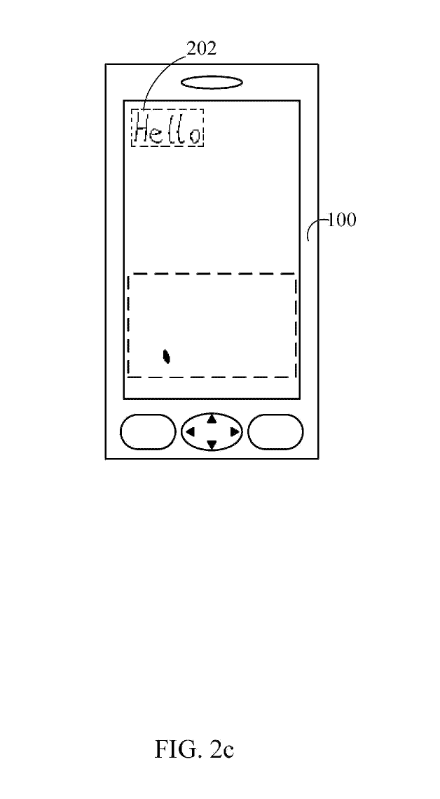

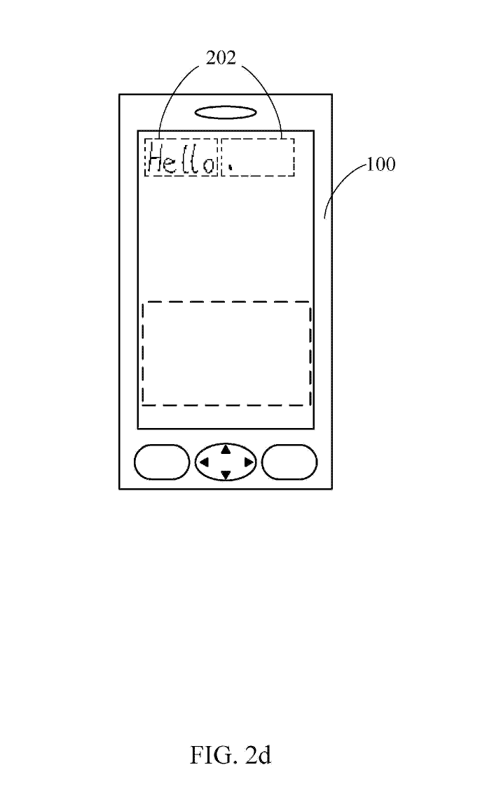

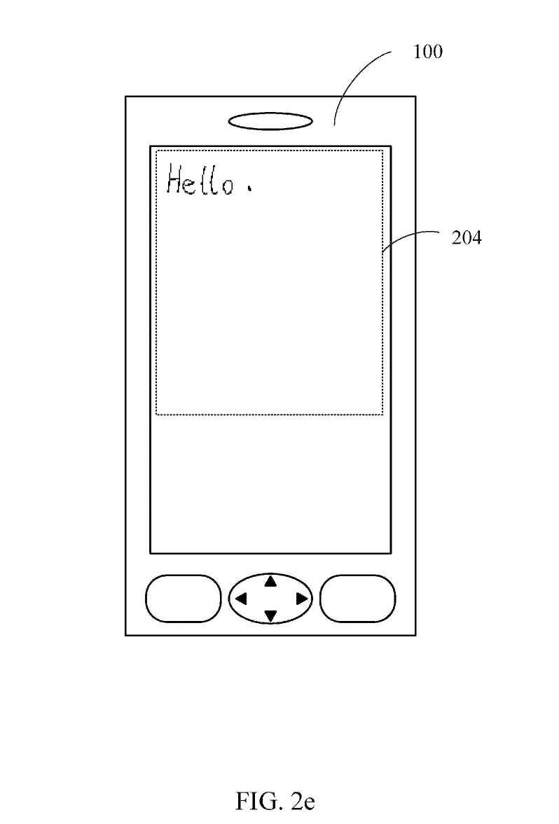

Referring also to FIGS. 2a-2e, in the exemplary embodiment, when the handwriting input processing function is enabled, a text editing frame 200 is displayed. A handwriting input is inputted in the text editing frame 200 by touching or using the stylus on the touchscreen 102. When a handwriting input, e.g., “Hello”, is completed (referring to FIG. 2a), the processing unit 104 captures, photographs or scans the content of the text editing frame 200 to generate the separate first image 202, e.g., “Hello”. The separate first image 202 is then transmitted to the storage unit 106 and the touchscreen 102 (referring to FIG. 2b). The touchscreen 102 displays the handwriting input “Hello”. When another handwriting input, such as a period, is complete (referring to FIG. 2c), the processing unit 104 generates another separate first image 202 including the handwriting input of the period. The another separate first image 202 is then outputted to the storage unit 106 and the touchscreen 102 (referring to FIG. 2d). As a result, two separate first images 202 are shown on the touchscreen 102. The dashed line showing peripheries of the two separate first images 202 and the resulting second image 204 is included for the purpose of illustrating peripheries of the two separate first images 202 and the resulting second image 204, which can be omitted from FIGS. 2b-2e.

When the handwritten message is complete, the return input may be performed, and the combining unit 110 is signaled to combine the separate first images stored in the storage unit 106 to generate the resulting second image 204 having the second predetermined size. The resulting second image 204 is then outputted to and displayed on the touchscreen 102, referring to FIG. 2e. Finally, the send input for sending the handwritten message may be received, and the communication unit 114 sends the resulting second image to a desired terminal, e.g. another telecommunication device.

In other embodiments, when receiving the return input, the resulting second image 204 will be generated and sent out wirelessly, and may not first be shown on the touchscreen 102. In other embodiments, when a separate first image is generated, the combining unit 110 generates a resulting second image including the separate first image. When another separate first image is generated, the combining unit 110 combines the another separate first image with the previously generated resulting second image to generate a new resulting second image. The finally resulting second image will be generated by analogy.

To sum up, when processing inputted messages, the telecommunication device 100 converts every inputted handwriting input into the separate first image having a first size. Then all the separate first images are combined into the resulting second image having a second size. The resulting second image is finally sent out wirelessly or stored in the telecommunication device 100 according to the received control/function selection input. Thus, the resulting second image can record more words or symbols than the image generated by the conventional telecommunication device. Furthermore, the user's handwriting is seen by receivers.

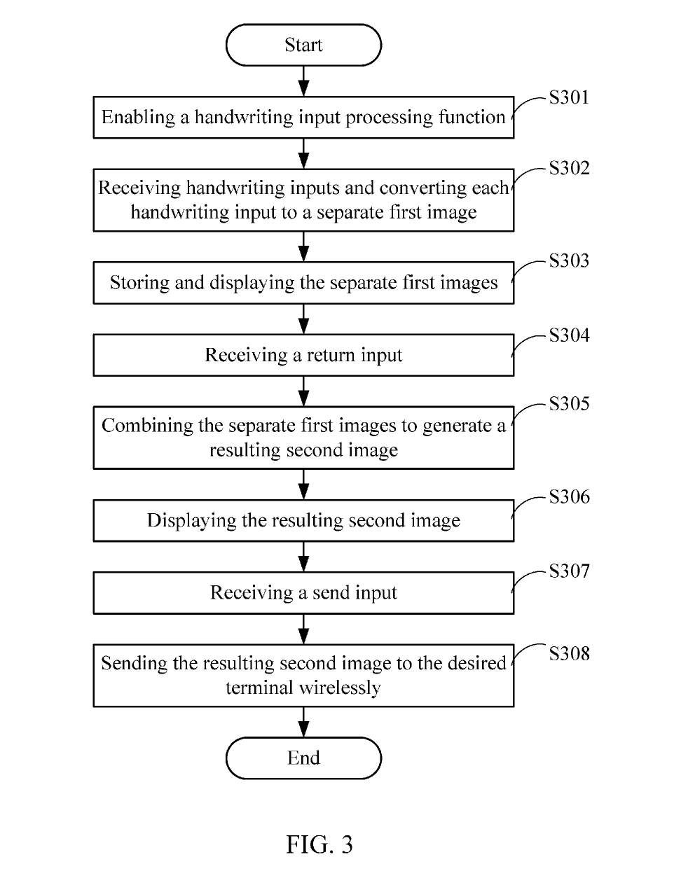

Referring to FIG. 3, in an exemplary embodiment, a handwriting input processing method using a telecommunication device, such as the telecommunication device 100, includes the following steps.

In step S301, the handwriting input processing function is enabled and a text editing frame is provided to the user. The user can input handwriting inputs in the text editing frame.

In step S302, handwriting inputs are converted into separate first images, each separate first image having a first predetermined size. Each separate first image includes a corresponding handwriting input. In the exemplary embodiment, whenever receiving a handwriting input, the area within the text editing frame is captured, photographed, or scanned to generate the separate first image including the handwriting input.

In step S303, storing and displaying the separate first images. The separate first images are arranged in accordance with an input order of the handwriting inputs.

In step S304, a return input sends a signal for combining the separate first images.

In step S305, the separate first images are combined to generate a resulting second image having a second predetermined size. In the exemplary embodiment, the resulting second image is generated by appending the separate first images, in consecutive order according to an input order of the handwriting inputs, to a blank image having the second predetermined size.

In step S306, the resulting second image is displayed.

In step S307, a send input signals sending the handwritten message to a desired terminal.

In step S308, the resulting second image is sent to the desired terminal wirelessly, for example, to another telecommunication device.

In other embodiments, steps S306 and S307 may be omitted from the handwriting input processing method.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A telecommunication device, comprising:
a touchscreen for receiving and recording handwriting inputs;
a processing unit for converting each handwriting input into a separate first image having a first predetermined size;
a storage unit for storing the separate first images generated by the processing unit;
a combining unit for combining the separate first images to generate a resulting second image having a second predetermined size; and
a communication unit for sending the resulting second image wirelessly.

2. The telecommunication device as described in claim 1, wherein the combining unit generates the resulting second image by appending the separate first images, in consecutive order according to an input order of the handwriting inputs, to a blank image having the second predetermined size.

3. The telecommunication device as described in claim 1, wherein the touchscreen is further used for displaying the separate first images.

4. The telecommunication device as described in claim 3, wherein the touchscreen is further used for displaying the resulting second image.

5. The telecommunication device as described in claim 3, further comprising a controller for enabling and disabling the processing unit and the combining unit.

6. The telecommunication device as described in claim 5, wherein the controller is further used for zooming out the separate first image.

7. The telecommunication device as described in claim 5, wherein the controller is further used for zooming in the separate first image.

8. The telecommunication device as described in claim 5, further comprising at least one key.

9. A handwriting input processing method, comprising:
receiving and recording handwriting inputs;
converting each handwriting input into a separate first image having a first predetermined size correspondingly, and storing the separate first image; and
combining the separate first images to generate a resulting second image having a second predetermined size including the separate first images.

10. The handwriting input processing method as claimed in claim 9, further comprising sending the resulting second image wirelessly.

11. The handwriting input processing method as claimed in claim 9, further comprising enabling a touchscreen to receive and record the handwriting inputs.

12. The handwriting input processing method as described in claim 9, wherein the resulting second image is generated by appending the separate first images, in consecutive order in accordance with an input order of the handwriting inputs, to a blank image having the second predetermined size.

13. The handwriting input processing method as described in claim 9, further comprising displaying the separate first images.

14. The handwriting input processing method as described in claim 9, further comprising receiving inputted control inputs, and enabling and disabling the processing unit and the combining unit in response to the control inputs.

15. The handwriting input processing method as described in claim 9, further comprising receiving inputted control inputs, and zooming out the separate first image.

16. The handwriting input processing method as described in claim 9, further comprising receiving inputted control inputs, and zooming in the separate first image.

17. The handwriting input processing method as described in claim 9, wherein the step of converting the handwriting input into the separate first image comprising:
providing a text editing frame;
receiving the handwriting input wrote in the text editing frame; and
photographing the whole text editing frame to generate the separate first image comprising the handwriting input.
